(19) United States
(12) Patent Application Publication
(10) Pub. No.: US 2008/0083739 A1
(43) Pub. Date: Apr. 10, 2008

(54) Portable toaster

(76) Inventor: Lloyd B. McLean, Orlando, FL (US)

Correspondence Address: Taylor J. Ross, Esq., 13521 Eyas Road, Orlando, FL, 32837, US

(21) Appl. No.: 11/526,427

(22) Filed: Sep. 25, 2006

(51) Int. Cl. H05B 1/02

(52) U.S. Cl. 219/519

(57) ABSTRACT

A portable toaster capable of operation by several power sources, including a dynamo unit. The toaster further includes recessed control handles and knobs so that it presents a prismatic form well suited to packing and requiring minimal storage space. To prevent ingress of moisture or debris, a cover may be selectively moved to cover the food slots. The cover may be associated with an interlock switch to prevent operation of the toaster while the cover is closed.

### BACKGROUND OF THE INVENTION

The present invention relates in general to toasters for warming and toasting bread slices, bagel slices, toaster pastries and similar foods. In particular, it relates to a portable electric toaster adapted for ease of transport, durability, and various modes of power.

### DESCRIPTION OF THE RELATED ART

A wide variety of electric toasters are known for use in the kitchen. These devices are powered by standard A/C outlets. Because of this reliance on standard power outlets, these toasters are poorly suited for use while camping or in the outdoors, and are incapable of operating in emergency situations involving power outages.

### SUMMARY OF THE INVENTION

An object of the present invention is to provide a toaster which may operate independently of a standard A/C power outlet for indefinite periods of time.

Another object of the present invention is to provide such a toaster which includes a dynamo unit to permit manual generation of the electrical power needed for operation.

A further object of the present invention is to provide a toaster which may operate from a variety of power sources: D/C current, A/C current, and dynamo unit.

Yet another object of the present invention is to provide such a toaster which is rugged and resistant to inclement weather.

Yet a further object of the present invention is to provide such a toaster which is easily packed and transported.

These and other objects are achieved by a portable toaster capable of operation by several power sources, including a dynamo unit. The toaster further includes recessed control handles and knobs so that it presents a prismatic form well suited to packing and requiring minimal storage space. To prevent ingress of moisture or debris, a cover may be selectively moved to cover the food slots. The cover may be associated with an interlock switch to prevent operation of the toaster while the cover is closed.

### BRIEF DESCRIPTION OF THE DRAWINGS

The objects and features of the invention noted above are explained in more detail with reference to the drawings, in which like reference numerals denote like elements, and in which:

FIG. 1 is a perspective view of a toaster according to the present invention;

FIG. 2 is a detail perspective view of the toaster of FIG. 1, showing the dynamo crank;

FIG. 3 is a cross-sectional side view along line 3-3 of FIG. 1; and

FIG. 4 is an exploded cross-sectional side view as in FIG. 3, but showing the cover in the closed position.

### DETAILED DESCRIPTION OF THE INVENTION

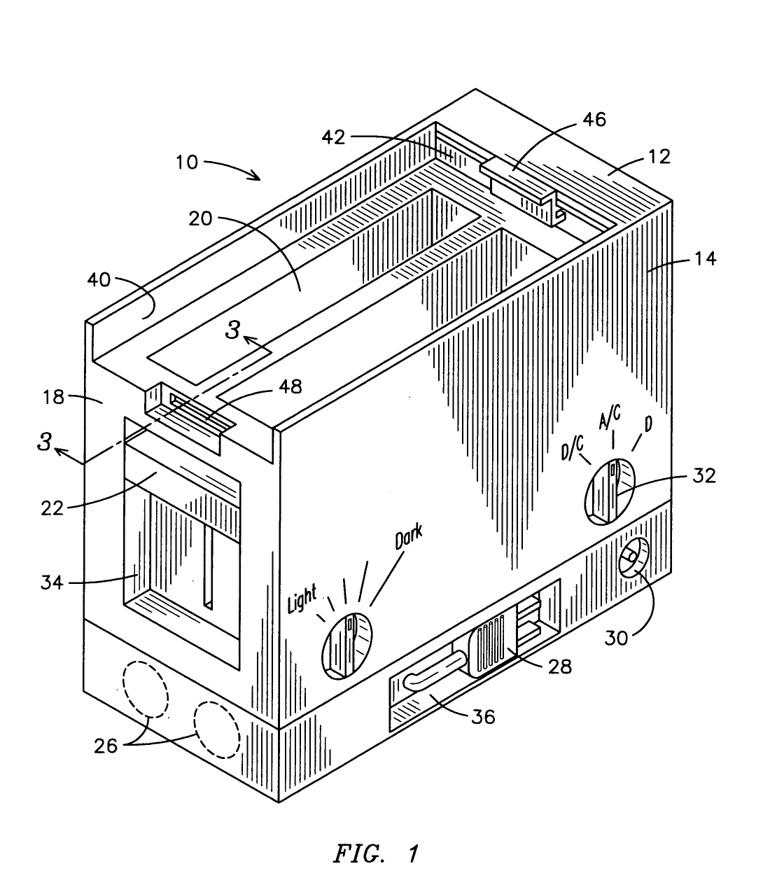

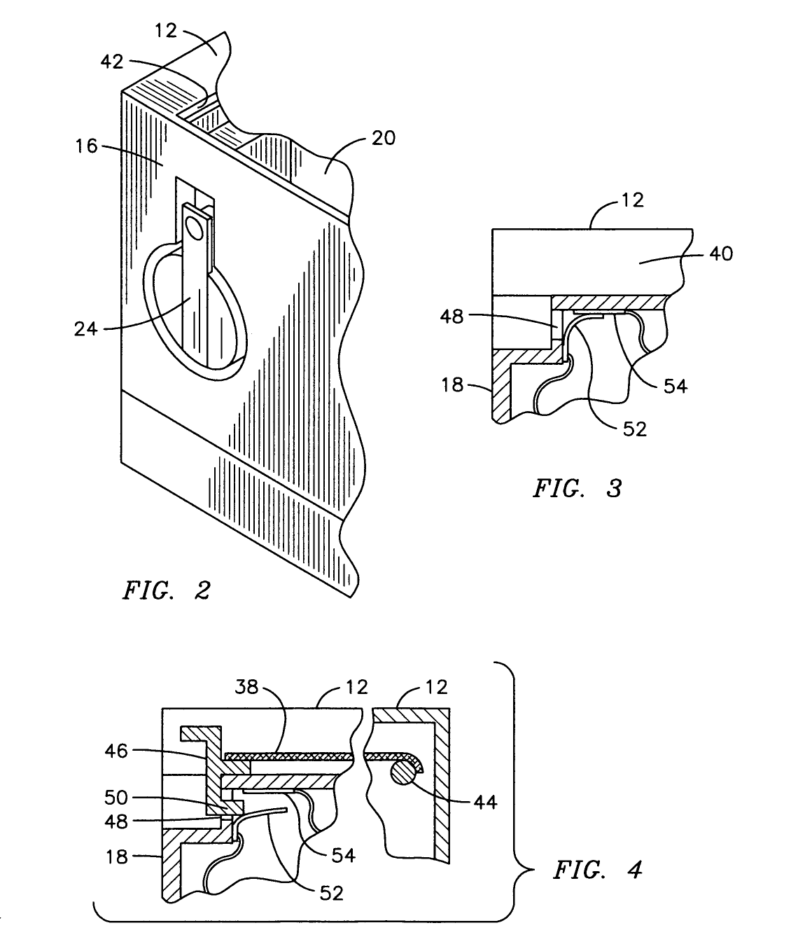

With reference to FIG. 1, a portable toaster according to the present invention is generally designated by reference numeral 10. The toaster 10 takes the general form of a cube or rectangular prism having: a top face 12 and a generally parallel bottom face (not shown); a first lateral face 14 and generally parallel second lateral face 16 (face 16 being shown in FIG. 2); and a first end face 18 and generally parallel second end face (not shown). These faces may be formed of various durable materials, such as metal, high-temperature resistant plastic, or composites.

As is common with most electric toasters, the top face 12 includes one or more food receptacle slots 20. In the embodiment shown, two such slots 20 are provided. These may be of the narrow variety for standard bread slices, or of the wider variety for bagel slices, etc. As well known in the prior art, within the toaster 10 and operatively associated with each slot 20 are various resistance elements (not shown) generating heat to toast the food within the slot upon an electric current passing through the elements.

As is also known in the art, each slot 20 includes a carriage (not shown) which supports the food item within the slot. The carriage moves between an upper, inoperative position and a lower, operative position during use of the toaster. As is well known, the carriage (or more than one carriage) may be manually moved between these upper and lower positions by an actuation bar 22 operatively connected to the carriage (or carriages). As is also well known, the resistance elements associated with the slot 20 are activated only upon the bar 22 (or the associated carriage) moving to the lower position so that the current flows through the elements only when the food item is received fully within the slot 20.

While these various features are common with other known toasters, the toaster 10 according to the present invention includes various other features which make it suitable for use outside the normal kitchen.

As a first example, the toaster 10 may be powered by various forms of electrical energy. In particular, it is desired that the toaster 10 include a dynamo mechanism, including a manual activator 24 (FIG. 2) operatively associated with one or more rechargeable batteries 26 (FIG. 1). In the embodiment shown, manual activator 24 takes the form of a manual crank well know to dynamo mechanism, but it may also take the form of a slide bar, an oscillating arm, or other known arrangements. Such dynamo mechanisms are well known for use with emergency flashlights and radios. The mechanism employed here may be quite similar.

The use of the dynamo mechanism ensures that the toaster 10 may be provided with the necessary electrical energy for operation outside the home during camping expeditions. Further, it will also allow operation of the toaster 10 during long duration emergency situations such as hurricane, earthquake, flood, etc. when standard electrical power is unavailable. This ability to operate independently of a standard power grid, refreshed batteries, or any other outside power source is considered to be a main advantage of the present toaster.

While the use of the dynamo mechanism permits independent operation, there are many situations where more conventional power sources are still available. To avoid the need for manual manipulation of activator 24 for each operation of toaster 10, it is preferred that the toaster 10 also include arrangements for alternative energy supply.

For example, the toaster 10 may include a standard power cord 28 for use with alternating current. Alternatively or additionally, the toaster 10 may also include a jack 30 for connecting a direct current power cord. These two alternative arrangements will allow use of the toaster 10 in homes or in cars and RVs. While the A/C power supply has been show with a cord, and the D/C power supply has been shown as a jack, it should be clear that this arrangement could be: reversed; both supplies could be provided with cords (and plugs); or both could be in the form of jacks for use with separate cords (not shown).

With the provision of alternative power supplies comes the need to switch between these supplies. As such, the toaster 10 may be provided with a power supply switch 32. This switch would have appropriate settings for the various forms of power supply available. While shown as a rotary switch, the power supply switch 32 may take other known forms, such as linear.

Independently of the inventive use of a dynamo unit to power the toaster 10, the present invention also envisions a unique form to permit ease of packing for transport (or storage). The toaster 10 according to the present invention preferably will have essentially no protruding parts.

In particular, the various faces 12-18 of toaster 10 are essentially planar. For example, the actuation bare 22 will be located within a bar recess 34 such that the outer edge of bar 22 is essentially flush with the first end face 18. Similarly, the power cord 28 is provided in a retractable form with a plug recess 34 completely containing the cord 28 when not in use. As a further example, the power supply switch 32 is similarly recessed such that it too is essentially flush with the lateral face 14.

This arrangement will result in the toaster 10 having an extremely prismatic form, allowing easier packing and storage. As should be clear, there are essentially no protruding parts to interfere with placement into small surroundings. This essentially prismatic form allows storage in the minimal amount of space.

Another independent aspect of the present invention is the shielding of the toaster against inclement weather. As noted previously, the toaster 10 is well suited for camping or situations of prolonged power outage associated with hurricane or similar disasters. The shielding of the toaster 10 permits increased durability in these demanding situations.

While the toaster 10 may be made completely waterproof, it is believed sufficient for most purposes that the major openings be shielded. As is common with most toasters, the major openings of toaster 10 are the food receptacle slots 20. To prevent rain, snow or debris from freely entering the slots 20, the toaster 10 includes a slot cover 38 (FIG. 4).

In the embodiment shown, the slots 20 are recessed below the level of top face 12, creating a shield recess 40 between the lateral faces 14 and 16. The recess 40 is also bounded by a short shield wall 42 spaced from the second end face. The space between the shield wall 42 and the second end face mounts a spring biased roller 44 (FIG. 4). This roller 44 is secured to an interior end of slot cover 38. The slot cover 38 may take the form of a flexible fabric which may be rolled upon, or unrolled from, the roller 44. As may be envisioned, the spring biasing of the roller 44 is such to roll the slot cover 38 onto the roller 44 in a first position corresponding to operation of the toaster, as shown in FIG. 1.

The slot cover 38 may be unrolled from roller 44 by manual pulling of its outer edge until it reaches a second position as shown in FIG. 4 where the toaster 10 would be inoperative due to the slots 20 being covered by the slot cover 38. To maintain the slot cover 38 in this second position the slot cover may include a latch 46 at its free end, and the latch may be selectively secured to a latch slot 48 adjacent the first end face 18.

In this second position the slot cover will extend over the slot(s) 20 preventing the ingress of most moisture or debris. This proximity to the slots 20, however, may result in the slot cover 20 experiencing relatively high temperatures. For this reason it is preferred that it be formed of a relatively heat resistant material.

To reduce the temperatures to which slot cover 38 is exposed, it is most preferred that the toaster 10 include interlock switch means to prevent operation of toaster 10 while the slot cover 10 is in the second position.

In the embodiment shown, this interlock switch means includes a leg 50 associated with the latch 40, with the leg 50 being the portion of latch 40 which enters the latch slot 48 to removably secure the latch 40 to the latch slot 48. The interlock switch means also includes a spring arm 52 and contact 54 operatively forming an operative part of the circuitry of the toaster 10 (and in particular the resistance elements). The spring arm 52 may be mounted in proximity to the latch slot 48 and be biased such that it normally touches the contact 54 to complete the operational circuit for toaster 10, as shown in FIG. 3.

As the user extends the slot cover 38 from its retracted position and engages the latch 46, the leg 50 extends through the latch slot 48 to abut the spring arm 52 and deflect it into a second position no longer touching the contact 54. As such, when the slot cover 38 is in its second position with the latch 46 engaged, the operative circuitry of toaster 10 is disabled and it is impossible for the heating elements to operate and damage slot cover 38. If the user takes the precaution of deploying slot cover 38 during storage, this will also prevent any unintended operation of the toaster 10 during storage, which could pose a fire hazard.

While slot cover 38 has been shown as a fabric member retractable upon a spring biased roller, various other configurations are possible. A rigid cover hinged for opening and closing could of course be used, in addition to various other arrangements. In each form, however, it is preferred that the interlock switch means be employed to prevent activation of toaster 10 while the cover is in the second, closed position.

From the foregoing it will be apparent that this invention is well adapted to attain all ends and objectives hereinabove set forth, in addition to other advantages which are obvious and inherent in the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the drawings is to be interpreted as illustrative, and not in a limiting sense.

What is claimed is:

1. In a portable toaster of the type including a housing, and one or more food slots in an upper face of said housing, and an actuation bar for manually moving food downward within said slots and activating said toaster, wherein the improvement comprises:
a dynamo unit including one or more rechargeable batteries operatively associated with said toaster to provide operating power.

2. The toaster of claim 1, further comprising:
one of a first group consisting of: an A/C power cord or an A/C power cord jack;
one of a second group consisting of: a D/C power cord or a D/C power cord jack; and
a power supply switch permitting the user to select between dynamo, A/C or D/C power supply.

3. The toaster of claim 2, wherein said first group consists of an A/C power cord selectively retractable within said housing.

4. The toaster of claim 1, wherein said actuation bar is located within a bar recess such that said actuation bar is essentially flush with said housing.

5. The toaster of claim 4, further comprising:
one of a first group consisting of: an A/C power cord or an A/C power cord jack;
one of a second group consisting of: a D/C power cord or a D/C power cord jack; and
a power supply switch permitting the user to select between dynamo, A/C or D/C power supply.

6. The toaster of claim 5, wherein said first group consists of an A/C power cord selectively retractable within said housing.

7. The toaster of claim 6, wherein said A/C power cord is received within a plug recess such that said power cord is essentially flush with said housing.

8. The toaster of claim 1, further comprising:
a slot cover movable between a first position allowing free access to said slots, and a second position in covering relation to said slots; and
a latch selectively engageable with said housing for securing said slot cover in said second position.

9. The toaster of claim 8, further comprising interlock switch means, and wherein engagement of said latch with said housing activates said interlock switch means to disable operation of said toaster.

10. The toaster of claim 9, wherein said actuation bar is located within a bar recess such that said actuation bar is essentially flush with said housing.

11. The toaster of claim 10, further comprising:
one of a first group consisting of: an A/C power cord or an A/C power cord jack;
one of a second group consisting of: a D/C power cord or a D/C power cord jack; and
a power supply switch permitting the user to select between dynamo, A/C or D/C power supply.

12. The toaster of claim 1 1, wherein said first group consists of an A/C power cord selectively retractable within said housing.

13. The toaster of claim 12, wherein said A/C power cord is received within a plug recess such that said power cord is essentially flush with said housing.
